(19) United States
(12) Patent Application Publication
(10) Pub. No.: US 2008/0112852 A1
(43) Pub. Date: May 15, 2008

(54) Test Strips and System for Measuring Analyte Levels in a Fluid Sample

(76) Inventors: Gary T. Neel, Weston, FL (US); Douglas E. Bell, Coral Springs, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/930,906

(22) Filed: Oct. 31, 2007

Related U.S. Application Data
(63) Continuation-in-part of application No. 11/590,854, filed on Nov. 1, 2006.
Application No. 11/590,854 is a continuation of application No. 10/706,458, filed on Nov. 12, 2003.
Application No. 10/706,458 is a division of application No. 10/286,648, filed on Nov. 1, 2002, now Pat. No. 6,743,635.
(60) Provisional application No. 60/375,017, filed on Apr. 25, 2002.
(60) Provisional application No. 60/375,019, filed on Apr. 25, 2002.
(60) Provisional application No. 60/375,020, filed on Apr. 25, 2002.
(60) Provisional application No. 60/375,054, filed on Apr. 25, 2002.

(51) Int. Cl. G01N 27/00

(52) U.S. Cl. 422/82.01; 422/56; 422/82.02

(57) ABSTRACT

A test strip for measuring an analyte level in a fluid sample includes a sample chamber configured to receive the fluid sample; a plurality of electrodes configured to produce at least one current measurement related to the analyte level in the fluid sample; and at least one information-providing connector having an intrinsic electrical property representative of at least one test strip calibration parameter specific to the test strip. A system for measuring an analyte level in a fluid sample may include such a test strip along with a data acquisition system controlled by a processor and configured to measure an intrinsic electrical property of the information-providing connector and to obtain at least one test strip calibration parameter corresponding to the test strip from at least one predetermined location in a memory based on the intrinsic electrical property.

### CROSS-REFERENCE TO RELATED APPLICATIONS

This application is a continuation-in-part of and claims priority to pending U.S. patent application Ser. No. 11/590,854, filed Nov. 1, 2006, which was a continuation of U.S. patent application Ser. No. 10/706,458, filed Nov. 12, 2003, which was a divisional of U.S. patent application Ser. No. 10/286,648, filed Nov. 1, 2002, which issued as U.S. Pat. No. 6,743,635 and which was based on and claimed priority to U.S. Provisional Patent Application Ser. No. 60/375,017, filed Apr. 25, 2002, U.S. Provisional Patent Application Ser. No. 60/375,019, filed Apr. 25, 2002, U.S. Provisional Patent Application Ser. No. 60/375,020, filed Apr. 25, 2002, and U.S. Provisional Patent Application Ser. No. 60/375,054, filed Apr. 25, 2002, all of which non-provisional and provisional applications being fully incorporated herein by reference. Claims 1, 2, and 10 are believed to be supported by the aforementioned non-provisional and provisional applications. Claims 3-9 and 11-20 may not be fully supported by the aforementioned non-provisional and provisional applications.

### BACKGROUND

1. Field of the Invention

The present invention relates to electrochemical sensors and, more particularly, to test strips and methods for measuring an analyte level in a fluid sample electrochemically.

2. Description of Related Art

Many people, such as diabetics, have a need to monitor their blood glucose levels on a daily basis. A number of systems that allow people to conveniently monitor their blood glucose levels are available. Such systems typically include a test strip where the user applies a blood sample and a meter that “reads” the test strip to determine the glucose level in the blood sample.

Among the various technologies available for measuring blood glucose levels, electrochemical technologies are particularly desirable because only a very small blood sample may be needed to perform the measurement. In electrochemical-based systems, the test strip typically includes a sample chamber that contains reagents, such as glucose oxidase and a mediator, and electrodes. When the user applies a blood sample to the sample chamber, the reagents react with the glucose, and the meter applies a voltage to the electrodes to cause a redox reaction. The meter measures the resulting current and calculates the glucose level based on the current.

It should be emphasized that accurate measurements of blood glucose levels may be critical to the long-term health of many users. As a result, there is a need for a high level of reliability in the meters and test strips used to measure blood glucose levels. However, as sample sizes become smaller, the dimensions of the sample chamber and electrodes in the test strip also become smaller. This, in turn, may make test strips become more sensitive to smaller manufacturing defects and to damage from subsequent handling.

Accordingly, there is a need to provide measuring systems for analytes such as glucose conveniently and reliably.

### SUMMARY

In a first principal aspect, the present invention provides a test strip for measuring an analyte level in a fluid sample, comprising: a sample chamber configured to receive the fluid sample; a plurality of electrodes configured to produce at least one current measurement related to the analyte level in the fluid sample; and at least one information-providing connector having an intrinsic electrical property representative of at least one test strip calibration parameter specific to the test strip.

In a second principal aspect, the present invention provides a system for measuring an analyte level in a fluid sample, comprising (1) a test strip including a sample chamber configured to receive the fluid sample; a plurality of electrodes configured to produce at least one current measurement related to the analyte level in the fluid sample; and at least one information-encoding connector having an intrinsic electrical property representative of at least one test strip calibration parameter specific to the test strip; and (2) a meter including a strip connector for receiving the test strip; a processor; a memory having a plurality of locations each configured to store at least one calibration parameter; and a data acquisition system controlled by the processor and configured to: measure an intrinsic electrical property of the at least one information-encoding connector; obtain at least one test strip calibration parameter corresponding to the test strip from at least one predetermined location in the memory based on the intrinsic electrical property of the at least one information-encoding connector; apply at least one voltage to at least one of the plurality of electrodes; and measure the at least one current measurement related to the analyte level.

### BRIEF DESCRIPTION OF THE DRAWINGS

FIG. 1 is a top plan view of a test strip, in accordance with a preferred embodiment of the present invention.

FIG. 2 is a top plan view of the test strip of FIG. 1, with the cover, adhesive layer, and reagent layer cut away, in accordance with a preferred embodiment of the present invention.

FIG. 3 is a cross-sectional view of the test strip of FIG. 1, taken along line 3-3, in accordance with a preferred embodiment of the present invention.

FIG. 4 is a perspective view of a meter, in accordance with a preferred embodiment of the present invention.

FIG. 5 is a perspective view of the meter of FIG. 4, with a removable data storage device inserted in it, in accordance with a preferred embodiment of the present invention.

FIG. 6 is a perspective view of a strip connector in the meter of FIG. 4, in accordance with a preferred embodiment of the present invention.

FIG. 7 is a simplified schematic diagram of the electronics of the meter of FIG. 4, in accordance with a preferred embodiment of the present invention.

FIG. 8 is a simplified schematic diagram of the electrical connections between the meter of FIG. 4 and the electrodes of the test strip of FIG. 1, in accordance with a preferred embodiment of the present invention.

FIG. 9 is a simplified schematic diagram of the electrical connections between the meter of FIG. 4 and the information-providing connector of the test strip of FIG. 1, in accordance with a preferred embodiment of the present invention.

### DETAILED DESCRIPTION OF THE PREFERRED EMBODIMENTS

In accordance with a preferred embodiment, a system for measuring a glucose level in a blood sample includes a test strip and a meter. The system may also include a check strip that the user may insert into the meter to check that the meter is functioning properly.

The test strip includes a sample chamber for receiving the blood sample. The sample chamber has a first opening in the proximal end of the test strip and a second opening for venting the sample chamber. The sample chamber may be dimensioned so as to be able to draw the blood sample in through the first opening, and to hold the blood sample in the sample chamber, by capillary action. The test strip may include a tapered section that is narrowest at the proximal end, in order to make it easier for the user to locate the first opening and apply the blood sample.

A working electrode, a counter electrode, a fill-detect electrode, and a fill-detect anode are disposed in the sample chamber. A reagent layer is disposed in the sample chamber and preferably covers at least the working electrode. The reagent layer may include an enzyme, such as glucose oxidase, and a mediator, such as potassium ferricyanide. The test strip has, near its distal end, a plurality of electrical contacts that are electrically connected to the electrodes via conductive traces. The test strip also has near its distal end at least one information-providing or information-encoding connector, which may be electrically isolated from the electrodes, having at least one intrinsic electrical property representative of at least one test strip calibration parameter specific to the test strip.

The meter may be battery powered and may stay in a low-power sleep mode when not in use in order to save power. When the test strip is inserted into the meter, the electrical contacts on the test strip contact corresponding electrical contacts in the meter. In addition, the information-providing connector bridges a pair of electrical contacts in the meter, causing a current to flow through the information-providing connector. The current flow through the information-providing connector may causes the meter to wake up and enter an active mode. The meter also measures an intrinsic electrical property of the information-providing connector as the current flows and determines on the basis of the measured intrinsic electrical property at least one test strip calibration parameter specific to the test strip. If the meter detects a check strip, it performs a check strip sequence. If the meter detects a test strip, it performs a test strip sequence.

In the test strip sequence, the meter validates the working electrode, counter electrode, and fill-detect electrodes by confirming that there are no low-impedance paths between any of these electrodes. If the electrodes are valid, the meter indicates to the user that sample may be applied to the test strip. The meter then applies a drop-detect voltage between the working and counter electrodes and detects the blood sample by detecting a current flow between the working and counter electrodes (i.e., a current flow through the blood sample as it bridges the working and counter electrodes). To detect that adequate sample is present in the sample chamber and that the blood sample has traversed the reagent layer and mixed with the chemical constituents in the reagent layer, the meter applies a fill-detect voltage between the fill-detect electrodes and measures any resulting current flowing between the fill-detect electrodes. If this resulting current reaches a sufficient level within a predetermined period of time, the meter indicates to the user that adequate sample is present and has mixed with the reagent layer.

The meter waits for an incubation period of time after initially detecting the blood sample, to allow the blood sample to react with the reagent layer. Then, during a measurement period, the meter applies an assay voltage between the working and counter electrodes and takes one or more measurements of the resulting current flowing between the working and counter electrodes. The assay voltage is near the redox potential of the chemistry in the reagent layer, and the resulting current is related to the glucose level in the blood sample. The meter calculates the glucose level based on the measured current and on calibration data derived from the intrinsic electrical property representative of the at least one information-providing connector. The meter then displays the calculated glucose level to the user.

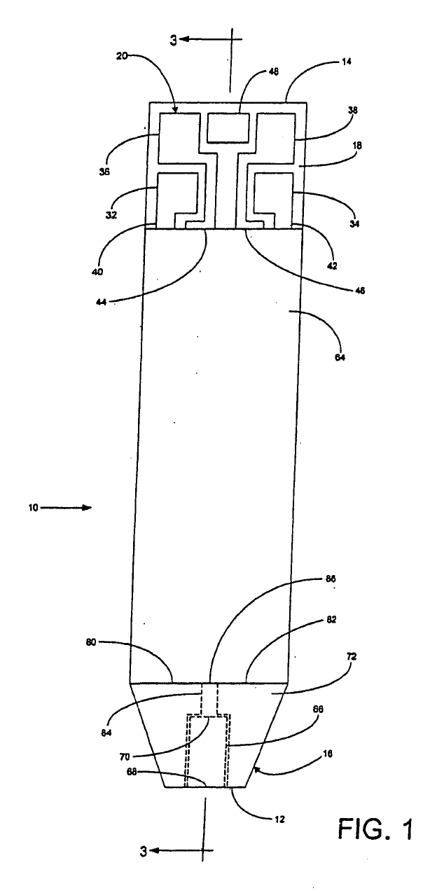

With reference to the drawings, FIGS. 1, 2, and 3 show a test strip 10, in accordance with a preferred embodiment of the present invention. Test strip 10 preferably takes the form of a generally flat strip that extends from a proximal end 12 to a distal end 14. Preferably, test strip 10 is sized for easy handling. For example, test strip 10 may be about 1⅜ inches along its length (i.e., from proximal end 12 to distal end 14) and about 5/16 inches wide. However, proximal end 12 may be narrower than distal end 14. Thus, test strip 10 may include a tapered section 16, in which the full width of test strip 10 tapers down to proximal end 12, making proximal end 12 narrower than distal end 14. As described in more detail below, the user applies the blood sample to an opening in proximal end 12 of test strip 10. Thus, providing tapered section 16 in test strip 10, and making proximal end 12 narrower than distal end 14, may help the user to locate the opening where the blood sample is to be applied and may make it easier for the user to successfully apply the blood sample to test strip 10.

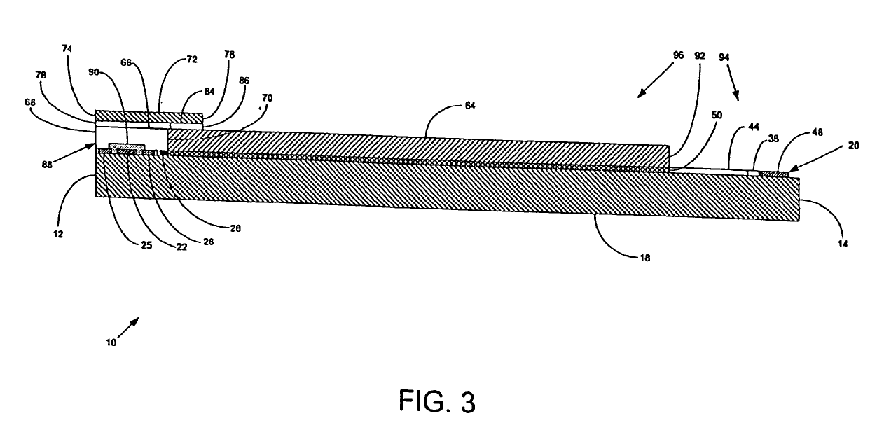

As best shown in FIG. 3, test strip 10 may have a generally layered construction. Working upward from the lowest layer, test strip 10 may include a base layer 18 extending along the entire length of test strip 10. Base layer 18 is preferably composed of an electrically insulating material and has a thickness sufficient to provide structural support to test strip 10. For example, base layer 18 may be polyester that is about 0.014 inches think.

Disposed on base layer 18 is a conductive pattern 20. Conductive pattern 20 includes a plurality of electrodes disposed on base layer 18 near proximal end 12, a plurality of electrical contacts disposed on base layer 18 near distal end 14, and a plurality of conductive traces electrically connecting the electrodes to the electrical contacts. In a preferred embodiment, the plurality of electrodes includes a working electrode 22, a counter electrode 24, which may include a first section 25 and a second section 26, a fill-detect anode 28, and a fill-detect cathode 30. Correspondingly, the electrical contacts may include a working electrode contact 32, a counter electrode contact 34, a fill-detect anode contact 36, and a fill-detect cathode contact 38. The conductive traces may include a working electrode trace 40, electrically connecting working electrode 22 to working electrode contact 32, a counter electrode trace 42, electrically connecting counter electrode 24 to counter electrode contact 34, a fill-detect anode trace 44 electrically connecting fill-detect anode 28 to fill-detect contact 36, and a fill-detect cathode trace 46 electrically connecting fill-detect cathode 30 to fill-detect cathode contact 38. In a preferred embodiment, conductive pattern 20 also includes information-providing or information encoding connector 48 disposed on base layer 18 near distal end 14.

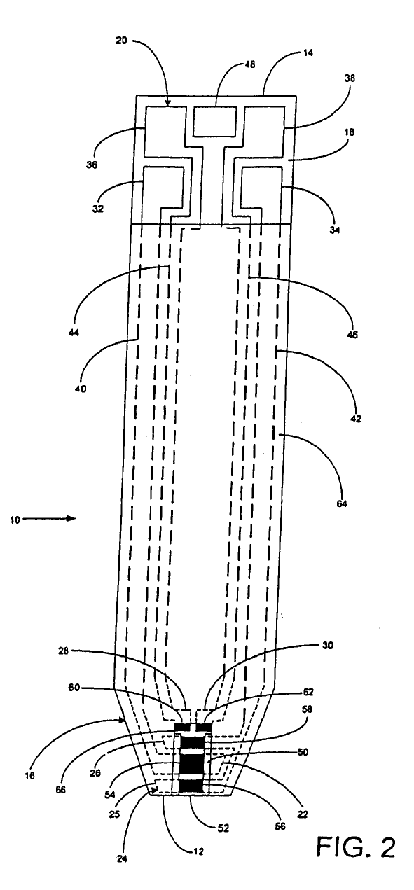

A dielectric layer 50 may also be disposed on base layer 18, so as to cover portions of conductive pattern 20. Preferably, dielectric layer 50 is a thin layer (e.g., about 0.0005 inches thick) and is composed of an electrically insulating material, such as silicones, acrylics, or mixtures thereof. Dielectric layer 50 may cover portions of working electrode 22, counter electrode 24, fill-detect anode 28, fill-detect cathode 30, and conductive traces 40-46, but preferably does not cover electrical contacts 32-38 or information-providing connector 48. For example, dielectric layer 50 may cover substantially all of base layer 18, and the portions of conductive pattern 20 thereon, from a line just proximal of contacts 32 and 34 all the way to proximal end 12, except for a slot 52 extending from proximal end 12. In this way, slot 52 may define an exposed portion 54 of working electrode 22, exposed portions 56 and 58 of sections 25 and 26 of counter electrode 24, an exposed portion 60 of fill-detect anode 28, and an exposed portion 62 of fill-detect cathode 30. As shown in FIG. 2, slot 52 may have different widths in different sections, which may make exposed portions 60 and 62 of fill-detect electrodes 28 and 30 wider than exposed portions 54, 56, and 58 of working electrode 22 and counter electrode sections 25 and 26.

The next layer in test strip 10 may be a dielectric spacer layer 64 disposed on dielectric layer 50. Dielectric spacer layer 64 is composed of an electrically insulating material, such as polyester. Dielectric spacer layer 64 may have a length and width similar to that of dielectric layer 50. In addition, spacer 64 may include a slot 66 that is substantially aligned with slot 52. Thus, slot 66 may extend from a proximal end 68, aligned with proximal end 12, back to a distal end 70, such that exposed portions 54-62 of working electrode 22, counter electrode 24, fill-detect anode 28, and fill-detect cathode 30 are located in slot 66.

A cover 72, having a proximal end 74 and a distal end 76, may be attached to dielectric spacer layer 64 via an adhesive layer 78. Cover 72 is composed of an electrically insulating material, such as polyester, and may have a thickness of about 0.004 inches. Preferably, cover 72 is transparent.

Adhesive layer 78 may include a polyacrylic or other adhesive and have a thickness of about 0.0005 inches. Adhesive layer 78 may consist of a first section 80 and a second section 82 disposed on spacer 64 on opposite sides of slot 66. A break 84 in adhesive layer 78 between sections 80 and 82 extends from distal end 70 of slot 66 to an opening 86. Cover 72 may be disposed on adhesive layer 78 such that its proximal end 74 is aligned with proximal end 12 and its distal end 76 is aligned with opening 86. In this way, cover 72 covers slot 66 and break 84.

Slot 66, together with base layer 18 and cover 72, defines a sample chamber 88 in test strip 10 for receiving a blood sample for measurement. Proximal end 68 of slot 66 defines a first opening in sample chamber 88, through which the blood sample is introduced into sample chamber 88. At distal end 70 of slot 66, break 84 defines a second opening in sample chamber 88, for venting sample chamber 88 as sample enters sample chamber 88. Slot 66 is dimensioned such that a blood sample applied to its proximal end 68 is drawn into and held in sample chamber 88 by capillary action, with break 84 venting sample chamber 88 through opening 86, as the blood sample enters. Moreover, slot 66 is dimensioned so that the blood sample that enters sample chamber 88 by capillary action is about 1 microliter or less. For example, slot 66 may have a length (i.e., from proximal end 68 to distal end 70) of about 0.140 inches, a width of about 0.060 inches, and a height (which may be substantially defined by the thickness of dielectric spacer layer 64) of about 0.005 inches. Other dimensions could be used, however.

A reagent layer 90 is disposed in sample chamber 88. Preferably, reagent layer 90 covers at least exposed portion 54 of working electrode 22. Most preferably, reagent layer 90 also at least touches exposed portions 56 and 58 of counter electrode 24. Reagent layer 90 includes chemical constituents to enable the level of glucose in the blood sample to be determined electrochemically. Thus, reagent layer 90 may include an enzyme specific for glucose, such as glucose oxidase, and a mediator, such as potassium ferricyanide. Reagent layer 90 may also include other components, such as buffering materials (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), and surfactants (e.g., Triton X-100 or Surfynol 485).

With these chemical constituents, reagent layer 90 reacts with glucose in the blood sample in the following way. The glucose oxidase initiates a reaction that oxidizes the glucose to gluconic acid and reduces the ferricyanide to ferrocyanide. When an appropriate voltage is applied to working electrode 22, relative to counter electrode 24, the ferrocyanide is oxidized to ferricyanide, thereby generating a current that is related to the glucose concentration in the blood sample.

As best shown in FIG. 3, the arrangement of the various layers in test strip 10 may result in test strip 10 having different thicknesses in different sections. In particular, among the layers above base layer 18, much of the thickness of test strip 10 may come from the thickness of spacer 64. Thus, the edge of spacer 64 that is closest to distal end 14 may define a shoulder 92 in test strip 10. Shoulder 92 may define a thin section 94 of test strip 10, extending between shoulder 92 and distal end 14, and a thick section 96, extending between shoulder 92 and proximal end 12. The elements of test strip 10 used to electrically connect it to the meter, namely, electrical contacts 32-38 and information-providing conductor 48, may all be located in thin section 94. Accordingly, the connector in the meter may be sized so as to be able to receive thin section 94 but not thick section 96, as described in more detail below. This may beneficially cue the user to insert the correct end, i.e., distal end 14 in thin section 94, and may prevent the user from inserting the wrong end, i.e., proximal end 12 in thick section 96, into the meter.

Although FIGS. 1-3 illustrate a preferred configuration of test strip 10, other configurations could be used. For example, in the configuration shown in FIGS. 1-3, counter electrode 24 is made up two sections, a first section 25 that is on the proximal side of working electrode 22 and a second section 26 that is on the distal side of working electrode 22. Moreover, the combined area of the exposed portions 56 and 58 of counter electrode 24 is preferably greater than the area of the exposed portion 54 of working electrode 22. In this configuration, counter electrode 24 effectively surrounds working electrode 22, which beneficially shields working electrode 22 electrically. In other configurations, however, counter electrode 24 may have only one section, such as first section 25.

Different arrangements of fill-detect electrodes 28 and 30 may also be used. In the configuration shown in FIGS. 1-3, fill-detect electrodes 28 and 30 are in a side-by-side arrangement. Alternatively, fill-detect electrodes 28 and 30 may be in a sequential arrangement, whereby, as the sample flows through sample chamber 88 toward distal end 70, the sample contacts one of the fill-detect electrodes first (either the anode or the cathode) and then contacts the other fill-detect electrode. In addition, although exposed portions 60 and 62 of fill-detect electrodes 28 and 30 are wider than exposed portions 54, 56, and 58 of working electrode 22 and counter electrode sections 25 and 26 in the embodiment shown in FIG. 2, they may have the same or a narrower width in other embodiments.

However they are arranged relative to each other, it is preferable for fill-detect electrodes 28 and 30 to be located on the distal side of reagent layer 90. In this way, as the sample flows through sample chamber 88 toward distal end 70, the sample will have traversed reagent layer 90 by the time it reaches fill-detect electrodes 28 and 30. This arrangement beneficially allows the fill-detect electrodes 28 and 30 to detect not only whether sufficient blood sample is present in sample chamber 88 but also to detect whether the blood sample has become sufficiently mixed with the chemical constituents of reagent layer 90. Thus, if reagent layer 90 covers working electrode 22, as is preferable, then it is preferable to locate fill-detect electrodes 28 and 30 on the distal side of working electrode 22, as in the configuration shown in FIG. 1-3, Other configurations may be used, however.

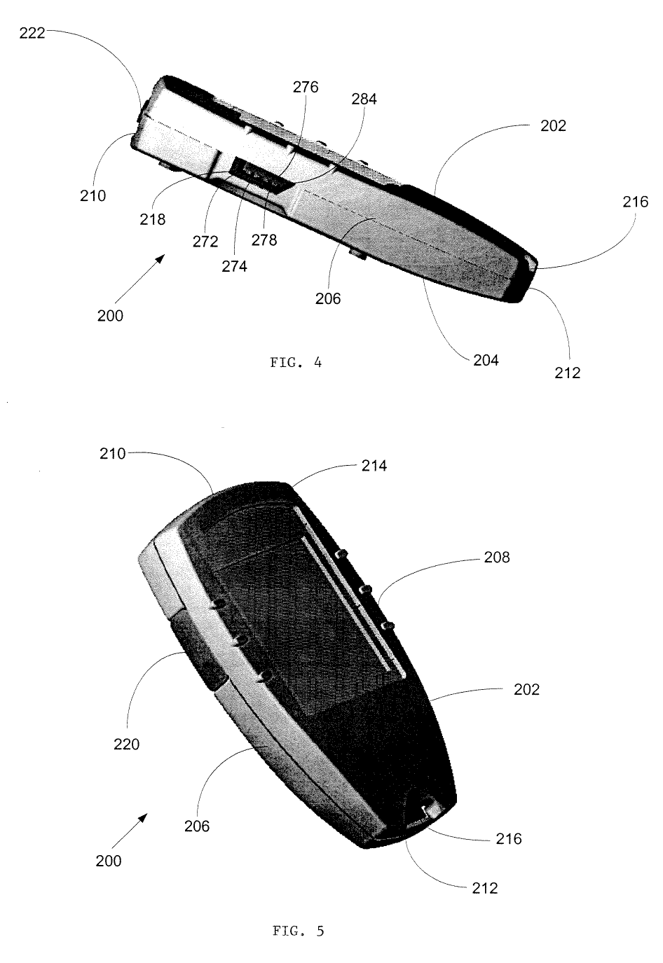

To measure the glucose level in a blood sample, test strip 10 is preferably used with a meter 200, as shown in FIG. 4. Preferably, meter 200 has a size and shape to allow it to be conveniently held in a user's hand while the user is performing the glucose measurement. Meter 200 may include a front side 202, a back side 204, a left side 206, a right side 208, a top side 210, and a bottom side 212. Front side 202 may include a display 214, such as a liquid crystal display (LCD). Bottom side 212 may include a strip connector 216 into which test strip 10 is inserted to conduct a measurement.

Left side 206 of meter 200 may include a data connector 218 into which a removable data storage device 220 may be inserted, as described in more detail below and illustrated in FIG. 5. Top side 210 may include one or more user controls 222, such as buttons, with which the user may control meter 200. Right side 208 may include a serial connector (not shown).

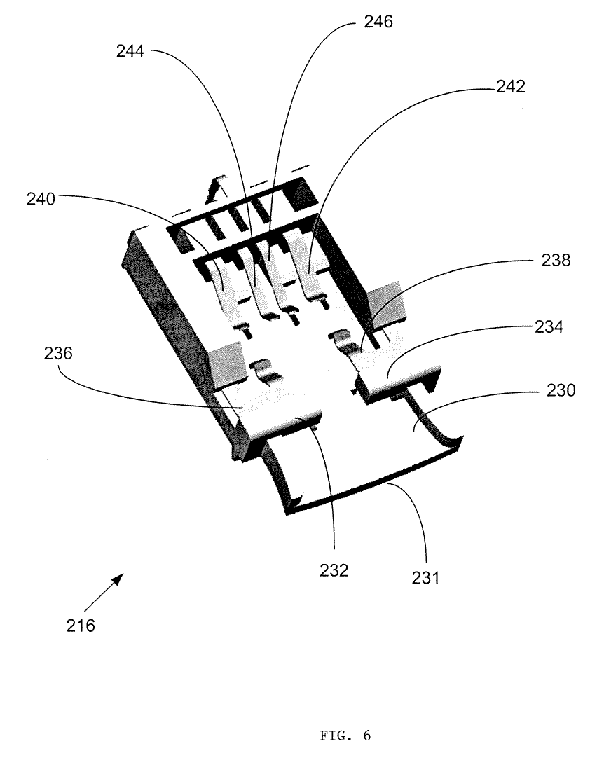

FIG. 6 shows a preferred embodiment of strip connector 216 in more detail. Strip connector 216 includes a channel 230 with a flared opening 231 for receiving test strip 10. Tabs 232 and 234 hang over the left and right sides, respectively, of channel 230 at a predetermined height. This predetermined height is set to allow distal end 14 (in thin section 94), but not proximal end 12 (in thick section 96), to be inserted into strip connector 216. In this way, the user may be prevented from improperly inserting test strip 10 into strip connector 216.

Electrical contacts 236 and 238 are disposed in channel 230 behind tabs 232 and 234, and electrical contacts 240-246 are disposed in channel 230 behind electrical contacts 236 and 238. When distal end 14 of test strip 10 is properly inserted into strip connector 216, electrical contacts 236-246 contact electrical contacts 32-38 and information-providing connector 48 to electrically connect test strip 10 to meter 200. In particular, electrical contacts 236 and 238 contact electrical contacts 32 and 34, respectively, to electrically connect working electrode 22 and counter electrode 24 to meter 200. Electrical contacts 240 and 242 contact electrical contacts 36 and 38, respectively, to electrically fill-detect electrodes 28 and 30 to meter 200. Finally, electrical contacts 244 and 246 electrically connect information-providing connector 48 to meter 200.

Meter 200 may use data from removable data storage device 220 to calculate glucose levels in blood samples measured by meter 200. Specifically, data storage device 220 may be associated with a lot of test strips and may store one or more parameters that meter 200 may use for that lot. For example, data storage device 220 may store one or more calibration parameters that meter 200 may use to calculate the glucose level from an averaged current measurement. The calibration parameters may include temperature corrections. Data storage device 220 may also store other information related to the lot of test strips and the meter, such as a code identifying the brand of test strips, a code identifying the model of meter to be used, and an expiration date for the lot of test strips. Data storage device 220 may also store other information used by meter 200, such as the duration of the fill timer and the incubation timer, the voltages to use for the “Drop Level 1,” “Fill,” and “Assay Excitation Level 2” voltages, one or more parameters relating to the number of current measurements to make, and one or more parameters specifying how the meter should average the current measurements, as described in more detail below. Data storage device 220 may also store one or more checksums of the stored data or portions of the stored data.

In a preferred approach, before a given lot of test strips are used with meter 200, the removable data storage device 220 associated with that given lot is first inserted into data connector 218. Meter 200 may then load the relevant data from data storage device 220 into an internal memory when a test strip is inserted into strip connector 216. With the relevant data stored in its internal memory, meter 200 no longer needs data storage device 220 to measure glucose levels using test strips in the given lot. Thus, removable data storage device 220 may be removed from meter 200 and may be used to code other meters. If data storage device 220 is retained in meter 200, meter 200 may no longer access it but instead use the data stored in its internal memory.

In a preferred embodiment, the need for a data storage device 220 can be obviated altogether by maintaining in the internal memory of the meter a master database of strip calibration parameters indexed according to an intrinsic electrical property of the information-providing connector 48. The intrinsic electrical property could be a resistance of the information-providing connector 48 or a voltage drop caused by the resistance, or any other measurable electrical property that can vary over a discrete or continuous range as the information-providing connector 48 on the strip bridges contacts 244 and 246 in meter 200. The at least one test strip calibration parameter can include, for example, one or more of temperature corrections, voltage parameters to be used by a meter performing measurements with the test strip, information about how many measurements should be made by a meter performing measurements with the test strip, an identifier identifying a lot of test strips to which the test strip belongs, a code identifying a brand of the test strip, a code identifying a model of meter to be used with the test strip, and an expiration date of the test strip.

As noted above, if the meter 200 detects a test strip, then meter 200 performs a test strip sequence. As a first phase of the test strip sequence, meter 200 may validate the working, counter, and fill-detect electrodes by determining whether the impedances between them are sufficiently high. If the electrodes are validated, meter 200 may then proceed to detect when the user applies the blood sample. To do so, meter 200 applies “Drop Level 1” voltage across working electrode 22 and counter electrode 24 and measures any resulting current flowing between these electrodes. As the user applies the blood sample to the opening of sample chamber 88 at proximal end 12, the blood sample will eventually bridge working electrode 22 and counter electrode 24, thereby providing an electrically conductive pathway between them. Meter 200 determines that a blood sample is present in sample chamber 88 when the resulting current reaches a predetermined threshold value or series of threshold values with an overall positive magnitude change. When meter 200 detects the blood sample in this way, meter 200 disconnects working and counter electrodes 22 and 24, putting them in a high impedance state relative to fill-detect electrodes 28 and 30, and meter 200 starts a fill timer and an incubation timer. Before meter 200 puts working and counter electrodes 22 and 24 in the high impedance state, meter 200 may first ground them to discharge stored charges.

The fill timer sets a time limit for the blood sample to traverse reagent layer 90 and reach fill-detect electrodes 28 and 30. The incubation timer sets a delay period to allow the blood sample to react with reagent layer 90. Once meter 200 starts the fill timer running, meter 200 applies a voltage, the “Fill” voltage, between fill-detect electrodes 28 and 30 and measures the resulting current flowing between these electrodes. Meter 200 checks whether the resulting current reaches a predetermined threshold value or a series of thresholds with an overall positive magnitude change before the fill timer elapses. Preferably, the current threshold(s) are set so that meter 200 can determine whether sufficient sample has reached fill-detect electrodes 28 and 30 and whether the sample has become mixed with the chemical constituents in reagent layer 90.

If the current does not reach the required value, then there may be some problem with test strip 10. For example, there may be a blockage in sample chamber 88. There may be an inadequate amount of sample. There may be no reagent layer, or the chemical constituents reagent layer may have failed to mix with the blood sample. Any of these problems may make the glucose measurement unreliable. Accordingly, if the fill timer elapses without a sufficient current through fill-detect electrodes 28 and 30, meter 200 may indicate a failure status. Meter 200 may indicate this failure status by displaying an error message or icon on display 214 and/or by providing some other user-discernible indication. The duration of the fill timer may, for example, be in the range of 1 to 6 seconds.

If however, meter 200 detects sufficient current through fill-detect electrodes 28 and 30 before the fill timer elapses, then meter 200 may proceed with the glucose measurement process. Meter 200 may provide an indication to the user that meter 200 has detected adequate sample mixed with the chemical constituents of reagent layer 90. For example, meter 200 may beep, display a message or icon on display 214, or provide some other user-discernible indication. Preferably, meter 200 also disconnects fill-detect electrodes 28 and 30, bringing them to a high impedance state relative to working electrode 22 and counter electrode 24. Meter 200 may ground fill-detect electrodes 28 and 30 before putting them into the high impedance state in order to discharge stored charges. Meter 200 then waits for the incubation timer to elapse in order to allow sufficient time for the blood sample to react with reagent layer 90. The incubation timer may, for example, take about 2 seconds to about 10 seconds to elapse, depending on the implementation. In a preferred embodiment, the incubation timer lasts about 5 seconds.

When the incubation timer elapses, meter 200 applies the “Assay Excitation Level 2” voltage between working electrode 22 and counter electrode 24 and measures the resulting current flowing between these electrodes. Preferably, meter 200 measures the resulting current at a fixed sampling rate throughout a measurement period, to obtain a plurality of current measurements. The measurement period may last from about 4 seconds to about 15 seconds, depending on the implementation. In a preferred embodiment, the measurement period lasts about 5 seconds.

Meter 200 then determines the glucose level in the blood sample from the current measurements. In a preferred approach, meter 200 may average the current measurements to obtain an average current value at a predetermined point of time during the measurement period. Meter 200 may then use the calibration data obtained from removable data storage device 220 and stored in its internal memory, or access its internal memory at a location corresponding to the intrinsic electrical property to determine the appropriate set of calibration data to use with the test strip, to calculate the glucose level from the average current value. Meter 200 may also take a temperature reading and use the temperature reading to correct the measured glucose level for temperature dependence. In addition, meter 200 may check the validity of the current measurements by checking that the measured current decreases over time, as expected.

For example, in a preferred embodiment, meter 200 may take a predetermined number of current measurements (m1 . . . mM) in 0.1 second time intervals. The predetermined number, M, may, for example, range from 50 to 150, and it may be a parameter specified in removable data storage device 220. The meter may then average every n current measurements to provide a plurality of data points (d1 . . . dN). Thus, if n is equal to 3, the meter would calculate d1 by averaging m1, m2, and m3, and would calculated d2 by averaging m2, m3, and m4. The averaging parameter, n, may be a parameter specified in removable data storage device 220. One of the data points may then be selected as the center point for another level of averaging, in which the meter averages together the data points around and including the center point to provide a meter reading, X. Thus, if d2 is selected as the center point, then the meter may average d1, d2, and d3 together to calculate the meter reading, X. Removable data storage device 220 may store a parameter that specifies which of the data points to use as the center point for calculating the meter reading, X. Meter 200 then calculates the glucose level, Y, from the meter reading, X, and one or more calibration parameters, which may be specified in removable data storage device 220. For example, in a preferred embodiment, meter 200 may use three calibration parameters, a, b, and c, to calculate Y from the expression a+bX+c/X.

The calculated glucose level, Y, may not be temperature corrected, however. To correct for temperature, meter 200 may apply one or more temperature correction parameters, which may be specified in removable data storage device 220 or in the meter's internal memory at the location corresponding to the intrinsic electrical property. For example, in a preferred embodiment, the temperature-corrected glucose level may be calculated from the expression A+BT+CYT+DY, where A, B, C, and D are temperature correction parameters and T is a measured temperature. The calibration parameters A, B, C, and D may be specified in removable data storage device 220. In other embodiments, the temperature correction may use only a single parameter, S, which may be specified in removable data storage device 220. For example, the temperature-corrected glucose level may be calculated from the expression Y/[(1+S(T−21)].

If the current measurements appear valid, then meter 200 displays the glucose level, typically as a number, on display 214. Meter 200 may also store the measured glucose level, with a timestamp, in its internal memory.

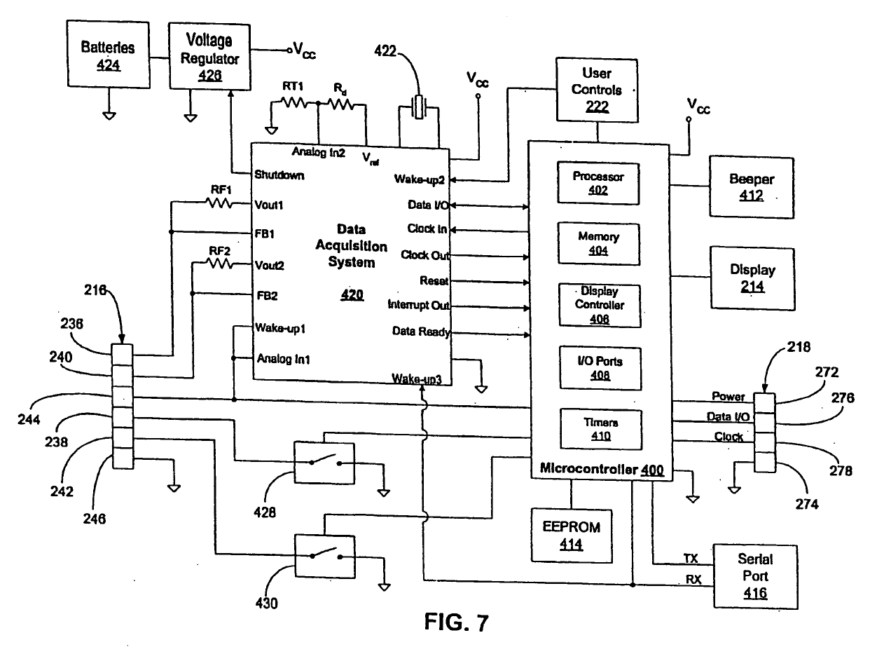

FIG. 7 shows, in simplified form, the electronic components of meter 200, in accordance with a preferred embodiment. Meter 200 may include a microcontroller 400 that controls the operation of meter 200 in accordance with programming, which may be provided as software and/or firmware. Microcontroller 400 may include a processor 402, a memory 404, which may include read-only memory (ROM) and/or random access memory (RAM), a display controller 406, and one or more input/output (I/O) ports 408. Memory 404 may store a plurality of machine language instructions that comprises the programming for controlling the operation of meter 200. Memory 404 may also store data, including an array of sets of calibration data indexed by a value corresponding to a measured intrinsic electrical property. Memory 404 may also store a table including a correspondence between values of one or more electrical properties and numerical values pointing to relevant memory locations. Each memory location can contain a large number of calibration data. Processor 402 executes the machine language instructions, which may be stored in memory 404 or in other components, to control microcontroller 400 and, thus, meter 200.

Microcontroller 400 may also include other components under the control of processor 402. For example, microcontroller 400 may include a display controller 406 to help processor 402 control display 214. In a preferred embodiment, display 214 is an LCD and display controller 406 is an LCD driver/controller. Microcontroller may also include I/O ports 408, which enable processor 402 to communicate with components external to microcontroller 400. Microcontroller 400 may also one or more timers 410. Processor 402 may use timers 410 to measure the fill time period, incubation time period, and other time periods described above. Microcontroller 400 may be provided as an integrated circuit, such as the HD64F38024H, available from Hitachi.

Microcontroller 400 is preferably connected to components that provide a user interface. The components that make up the user interface of meter 200 may include display 214, a beeper 412, and user controls 222. Microcontroller 400 may display text and/or graphics on display 214. Microcontroller may cause beeper 412 to beep, such as to indicate that adequate sample (mixed with the chemistry of reagent layer 90) has reached fill-detect electrodes 28 and 30, as described above. Microcontroller 400 may also be connected to other components, such as one or more light-emitting diodes (LEDs), to provide user-discernible indications, which may be visible, audible, or tactile. Microcontroller 400 may receive user input from user controls 222. In a preferred embodiment, user controls 222 consists of a plurality of discrete switches. However, user controls 222 may also include a touch screen or other components with which a user can provide input to meter 200.

Microcontroller 400 may have access to one or more memories external to it, such as an EEPROM 414. In a preferred embodiment, microcontroller 400 stores the measured glucose levels, and the times and dates the glucose measurements occurred, in EEPROM 414. By using user controls 222, the user may also be able to cause microcontroller 400 to display one or more of the glucose measurements stored in EEPROM 414 on display 214. Microcontroller 400 may also be connected to a serial port 416, through which the user can access the glucose measurements stored in EEPROM 414. Microcontroller 400 may use a transmit line, “TX,” to transmit signals to serial port 416 and may use a receive line, “RX,” to receive signals from serial port 416.

EEPROM 414 may also store the data from removable data storage device 220. In this regard, FIG. 7 shows how electrical contacts 272-278 of data connector 216 are connected inside of meter 200. Contact 272 is connected to a source of power, which may be through microcontroller 400. In this way, microcontroller 400 can do “power management,” powering removable data storage 220, through contact 272, only when necessary, e.g., when downloading data from removable data storage device 220. Contact 274 is connected to ground. Contacts 276 and 278 are connected to data input/output and clock outputs, respectively, of microcontroller 400. In this way, microcontroller 400 may download the data from data storage device 220, when connected to data connector 216, and store the data in EEPROM 414.

In a preferred embodiment, meter 200 also includes a data acquisition system (DAS) 420 that is digitally interfaced with microcontroller 400. DAS 420 may be provided as an integrated circuit, such as the MAX1414, available from Maxim Integrated Products, Sunnyvale, Calif.

DAS 420 includes one or more digital-to-analog converters (DACs) that generate analog voltages in response to digital data from microcontroller 400. In particular, DAS 420 includes “Vout1” and “FB1” terminals, which DAS 420 uses to apply analog voltages generated by a first DAC to working electrode 22, when test strip 10 is inserted in strip connector 216. Similarly, DAS 420 includes “Vout2” and “FB2” terminals, which DAS 420 uses to apply analog voltages generated by a second DAC to fill-detect anode 28, when test strip 10 is inserted in strip connector 216. The one or more DACs in DAS 420 generate analog voltages based on digital signals provided by microcontroller 400. In this way, the voltages generated by the one or more DACs may be selected by processor 402.

DAS 420 also includes one or more analog-to-digital converters (ADCs) with which DAS 420 is able to measure analog signals. As described in more detail below, DAS 420 may use one or more ADCs connected to the “Vout1” and “Vout2” terminals to measure currents from working electrode 22 and counter electrode 24, respectively, when test strip 10 is inserted in strip connector 216. DAS 420 may also include one or more other terminals through which the ADCs may measure analog signals, such as the “Analog In1” and “Analog In2” terminals shown in FIG. 7. DAS 420 may use the “Analog In1” terminal to measure the voltage across the auto-on conductor in a test strip or check strip that is connected to strip connector 216. The “Analog In2” terminal may be connected to a thermistor, RT1, to enable DAS 420 to measure temperature. In particular, DAS 420 may supply a reference voltage, Vref, through a voltage divider that includes thermistor, RT1, and another resister, Rd. DAS 420 may use the “Analog In2” terminal to measure the voltage across thermistor, RT1. DAS 420 transfers the digital values obtained from the one or more ADCs to microcontroller 400, via the digital interface between these components.

Preferably, DAS 420 has at least two modes of operation, a “sleep” or low-power mode and an “active” or run mode. In the active mode, DAS 420 has full functionality. In the sleep mode, DAS 420 has reduced functionality but draws much less current. For example, while DAS 420 may draw 1 mA or more in the active mode, DAS 420 may draw only microamps in the sleep mode. As shown in FIG. 7, DAS 420 may include “Wake-up1,” “Wake-up2,” and “Wake-up3” inputs. When appropriate signals are asserted at any of these “Wake-up” terminals, DAS 420 may wake up from the sleep mode, enter the active mode, and wake up the rest of meter 200, as described in more detail below. In a preferred embodiment, the “Wake-up” inputs are active-low inputs that are internally pulled up to the supply voltage, VCC. As described in more detail below, inserting the auto-on conductor in either a test strip or check strip into strip connector 216 causes the “Wake-up 1” input to go low and, thereby, causing DAS 420 to enter the active mode. In addition, the “Wake-up2” input may be connected to one or more of user controls 222. In this way, the user's actuation of at least certain of user controls 222 causes DAS 420 to enter the active mode. Finally, the “Wake-up3” input may be connected to serial port 416, e.g., via receive line, “RX.” In this way, attempting to use serial port 416 for data transfer may wake up DAS 420 and, hence, meter 200.

As shown in FIG. 7, DAS 420 includes several terminals that are connected to microcontroller 400. DAS 420 includes one or more “Data I/O” terminals, through which microcontroller 400 may write digital data to and read digital data from DAS 420. DAS 420 also includes a “Clock In” terminal that receives a clock signal from microcontroller 400 to coordinate data transfer to and from the “Data I/O” terminals. DAS 420 may also include a “Clock Out” terminal through which DAS 420 may supply a clock signal that drives microcontroller 400. DAS 420 may generate this clock signal by using a crystal 422. DAS 420 may also generate a real time clock (RTC) using crystal 422.

DAS 420 may also include other terminals through which DAS 420 may output other types of digital signals to microcontroller 400. For example, example DAS 420 may include a “Reset” terminal, through which DAS 420 may output a signal for resetting microcontroller 400. DAS 420 may also include one or more “Interrupt Out” terminals, which DAS 420 may use to provide interrupt signals to microcontroller 400. DAS 420 may also include one or more “Data Ready” inputs that DAS 420 may use to signal microcontroller 400 that DAS 420 has acquired data, such as from an analog-to-digital conversion, which is ready to be transferred to microcontroller 400.

As shown in FIG. 7, meter 200 may include a power source, such as one or more batteries 424. A voltage regulator 426 may provide a regulated supply voltage, VCC, from the voltage supplied by batteries 424. The supply voltage, VCC, may then power the other components of meter 200. In a preferred embodiment, voltage regulator 426 is a step-up DC-to-DC voltage converter. Voltage regulator 426 may be provided as an integrated circuit and other components, such as an inductor, capacitors, and resistors. The integrated circuit may, for example, be a MAX1724, available from Maxim Integrated Products, Sunnyvale, Calif.

Preferably, voltage regulator 426 has a shutdown mode, in which it provides only an unregulated output voltage. DAS 420 may include a “Shutdown” terminal through which DAS 420 may control voltage regulator 426. In particular, when DAS 420 enters the sleep mode, DAS 420 may assert a low level signal at its “Shutdown” terminal, causing voltage regulator 426 to enter the shutdown mode. When DAS 420 enters the active mode, it asserts a high level signal at its “Shutdown” terminal, allowing voltage regulator 426 to operate normally.

FIG. 7 also shows how electrical contacts 236-246 of strip connector 216 are connected in meter 200. Contacts 236 and 238, which are electrically connected to working electrode 22 and counter electrode 24, respectively, when test strip 10 is inserted in strip connector 216, are connected as follows. Contact 236, for working electrode 22, is connected to the “FB1” terminal of DAS 420 and connected via a resistor, RF1, to the “Vout1” terminal of DAS 420. Contact 238, for counter electrode 24, is connected to a switch 428. Switch 428 allows contact 238 (and, hence, counter electrode 24) to be connected to ground or left in a high impedance state. Switch 428 may be digitally controlled by microcontroller 400, as shown in FIG. 7. With counter electrode 24 connected to ground, DAS 420 may use the “Vout1” and “FB1” terminals to apply voltages to working electrode 22 (relative to counter electrode 24) and to measure the current through working electrode 22.

Contacts 240 and 242, which are electrically connected to fill-detect anode 28 and fill-detect cathode 30, respectively, when test strip 10 is inserted in strip connector 216, are connected as follows. Contact 240, for fill-detect anode 28, is connected to the “FB2” terminal of DAS 420 and connected via a resistor, RF2, to the “Vout2” terminal of DAS 420. Contact 242, for fill-detect cathode 30, is connected to a switch 430. Switch 430 allows contact 242 (and, hence, fill-detect cathode 30) to be connected to ground or left in a high impedance state. Switch 430 may be digitally controlled by microcontroller 400, as shown in FIG. 7. With fill-detect cathode 30 connected to ground, DAS 420 may use the “Vout2” and “FB2” terminals to apply voltages to fill-detect anode 28 (relative to fill-detect cathode 30) and to measure the current through fill-detect anode 28.

Switches 428 and 430 may be single-pole/single-throw (SPST) switches, and they may be provided as an integrated circuit, such as the MAX4641, available from Maxim Integrated Products, Sunnyvale, Calif. However, other configurations for switches 428 and 430 could be used.

Contacts 244 and 246, which are electrically connected to the information-providing conductor when a test strip or check strip is inserted into strip connector 216, are connected as follows. Contact 246 is connected to ground or other reference potential. Contact 244 is connected to the “Analog In1” and “Wake-up1” terminals of DAS 420 and to microcontroller 400. As described in more detail below, the presence of the information-encoding conductor can drive the “Wake-up 1” terminal low, thereby waking up DAS 420 and causing it to enter an active mode. DAS 420 uses the “Analog In1” terminal to measure the voltage across the information-encoding conductor. By virtue of its connection to contact 244, microcontroller 400 is able to determine whether the information-encoding conductor is present, and, thus, whether either a test strip or check strip is connected to strip connector 216.

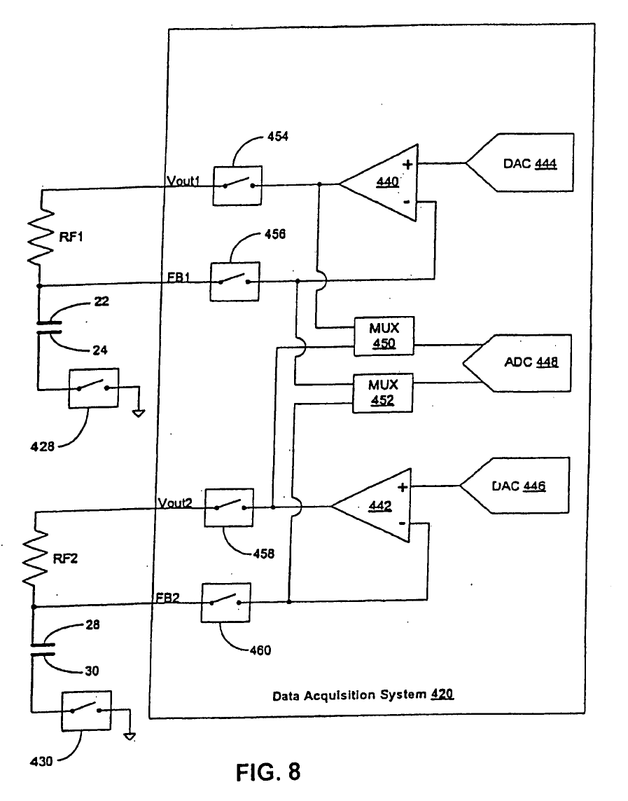

FIG. 8 shows in greater detail the functional aspects of the connections between meter 200 and electrodes 22, 24, 28, and 30, when test strip 10 is inserted in strip connector 216. As shown in FIG. 8, DAS 420 functionally includes an amplifier 440 for working electrode 22 and an amplifier 442 for fill-detect anode 28. More particularly, the output of amplifier 440 is connected to working electrode 22, via the “Vout1” terminal and resistor, RF1, and the inverting input of amplifier 440 is connected to working electrode 22, via the “FB1” terminal. Similarly, the output of amplifier 442 is connected to fill-detect anode 28, via the “Vout2” terminal and resistor, RF2, and the inverting input of amplifier 442 is connected to fill-detect anode 28, via the “FB2” terminal.

To generate selected analog voltages to apply to working electrode 22 and fill-detect electrode 28, DAS 420 includes a first DAC 444 and a second DAC 446, respectively. DAC 444 is connected to the non-inverting input of amplifier 440, and DAC 446 is connected to the non-inverting input of amplifier 442. In this way, amplifier 440 applies a voltage to the “Vout1” terminal, such that the voltage at working electrode 22, as sensed at the inverting input of amplifier 440, is essentially equal to the voltage generated by DAC 444. Similarly, amplifier 442 applies a voltage to the “Vout2” terminal, such that the voltage at fill-detect electrode 28, as sensed at the inverting input of amplifier 442, is essentially equal to the voltage generated by DAC 446.

To measure the currents through working electrode 22 and fill-detect anode 28, DAS 420 includes an ADC 448 and multiplexers (MUXes) 450 and 452. MUXes 450 and 452 are able to select the inputs of ADC 448 from among the “Vout1,” “FB1,” “Vout2,” and “FB2” terminals. DAS 420 may also include one or more buffers and/or amplifiers (not shown) between ADC 448 and MUXes 450 and 452. To measure the current through working electrode 22, MUXes 450 and 452 connect ADC 448 to the “Vout1” and “FB1” terminals to measure the voltage across resistor, RF1, which is proportional to the current through working electrode 22. To measure the current through fill-detect electrode 28, MUXes 450 and 452 connect ADC 448 to the “Vout2” and “FB2” terminals to measure the voltage across resistor, RF2, which is proportional to the current through fill-detect anode 28.

As noted above, meter 200 preferably includes switches 428 and 430 that may be used to bring counter electrode 24 and fill-detect cathode 30, respectively, into a high impedance state. It is also preferable for meter 200 to be able to bring working electrode 22 and fill-detect anode 28 into a high impedance state as well. In a preferred embodiment, this may be achieved by DAS 420 being able to bring terminals “Vout1,” “FB1,” “Vout2,” and “FB2” into high impedance states. Accordingly, DAS 420 may effectively include switches 454, 456, 458, and 460, as shown in FIG. 8. Although switches 428, 430, and 454-460 may be SPST switches, as shown in FIG. 8, other types of switches, such as single pole-double throw (SPDT) switches, may be used, and the switches may be arranged in other ways, in order to provide meter 200 with the ability to select one pair of electrodes (either the working and counter electrode pair or the fill-detect electrode pair) and leave the other pair of electrodes in a high impedance state. For example, a pair of SPDT switches may be used, with one SPDT switch selecting which of working electrode 22 and fill-detect 28 to connect to DAS 420 and the other SPDT switch selecting which of counter electrode 24 and fill-detect cathode to connect to ground. In other cases, meter 200 may not be configured to bring all of the electrodes into high impedance states. For example, in some embodiments, meter 200 may not include switch 428, with the result that counter electrode 24 is always connected to ground when test strip 10 is inserted in strip connector 216.

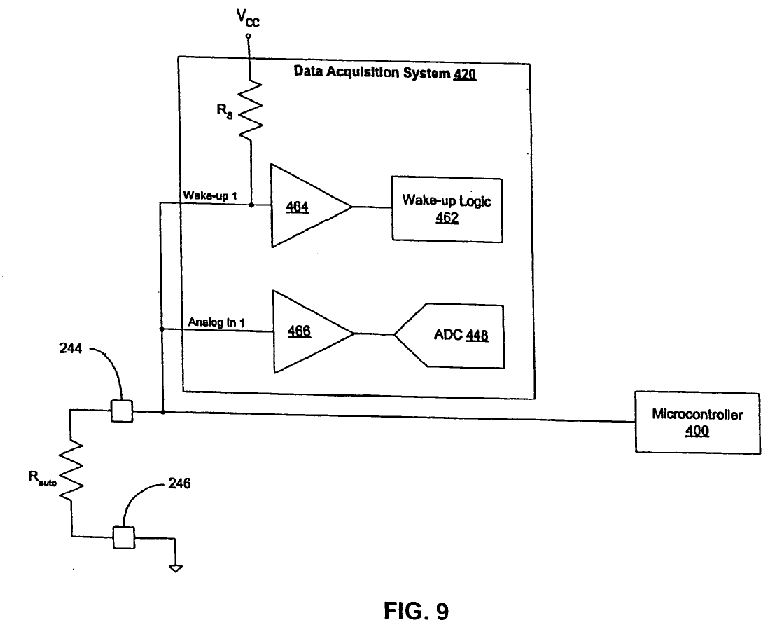

FIG. 9 shows in greater detail the functional aspects of the connections between meter 200 and the information-encoding connector when either a test strip or a check strip is inserted in strip connector 216. As shown in FIG. 9, the information-encoding connector provides an effective resistance, Rauto, between contacts 244 and 246 of strip connector 216. Within meter 200, contact 244 is connected to the source voltage, Vcc, through an effective resistance, RS. For example, the “Wake-up1” terminal of DAS 420, to which contact 244 is connected, may be internally pulled up to Vcc, through an effective resistance, RS. Accordingly, when either a test strip or a check strip is inserted into strip connector 216, such that the information-encoding connector bridges contacts 244 and 246, a current flows through the information-encoding connector and a voltage drop develops between contacts 244 and 246. The magnitude of this information-encoding connector voltage drop depends on the relative magnitudes of Rauto and RS. Preferably, Rauto is chosen sufficiently low for the test strips and check strips, relative to RS, such that the information-encoding connector voltage is less than the logic low voltage (which may be about 0.8 volts) used in meter 200. It is also preferable for Rauto to be substantially different in test strips and check strips, so that meter 200 may determine the strip type from the information-encoding connector voltage drop. For example, if RS is about 500 kΩ, then Rauto may be less than about 20Ω in a test strip and may be approximately 20 kΩ in a check strip. In this way, microcontroller 400 may determine that either a test strip or check strip is inserted in strip connector 216 by sensing a logic low voltage at contact 244. The actual value of Rauto, or any other measurable parameter, may be used to reference a memory location in the meter. Any range of resistance value could be used, provided that the meter can map the measured value to a numerical value pointing to a memory location in the meter, which can easily done using a correspondence table stored in the memory of the meter that maps resistance intervals (or voltage or any other property) to memory locations. Moreover, the density of information encoded using the actual value of Rauto, or any other measurable parameter, can be increased substantially by incorporating additional information-encoding connectors onto the test strips. Such additional information-encoding connectors could represent distinct information channels and may be used to carry distinct signals or redundant signals for verification purposes.

DAS 420 also senses the information-providing conductor voltage drop and uses it to wake up meter 200 and to determine the strip type, i.e., whether a test strip or a check strip has been inserted into strip connector 216. In the case of a test strip, DAS 420 may also confirm that the test strip has been properly inserted into strip connector 216.

DAS 420 may include wake-up logic 462, which senses the voltage at the “Wake-up 1” terminal, via one or more buffers and/or amplifiers, such as buffer 464. DAS 420 also includes ADC 448, which can measure the voltage at the “Analog In1” terminal, via one or more buffers and/or amplifiers, such as buffer 466. Although not shown in FIG. 9, MUXes 450 and 452 may be connected between buffer 466 and ADC 448.

When no strip is present in strip connector 216, contact 244 (and, thus, the “Wake-up1” terminal) is at a high voltage, at or near VCC. However, when either a test strip or a check strip is inserted in strip connector 216, the information-encoding connector drives the voltage at the “Wake-up1” terminal low, as described above. Wake-up logic 462 senses the voltage at the “Wake-up1” terminal going low and, in response, initiates a wake-up sequence to bring DAS 420 into an active mode. As part of this wake-up sequence, wake-up logic 462 may cause DAS 420 to assert a signal at its “Shutdown” terminal to turn on voltage regulator 426. Wake-up logic 462 may also cause DAS 420 to generate signals to wake up microcontroller 400. For example, wake-up logic 462 may cause DAS 420 to assert a clock signal through its “Clock Out” terminal, a reset signal through its “Reset” terminal, and an interrupt signal through its “Interrupt Out” terminal to activate microcontroller 400.

Though not shown in FIG. 9, wake-up logic 462 may also sense the voltages at the “Wake-up1” and “Wake-up2” terminals and, in response to a voltage at one of these terminals going low, may initiate a wake-up sequence similar to that described above.

When DAS 420 enters the active mode, it also determines the type of strip inserted into strip connector 216. In particular, ADC 448 measures the voltage at the “Analog In1” terminal. DAS 420 then reports the measured voltage to microcontroller 400. Based on this information, microcontroller 400 then initiates either a test strip sequence or a check strip sequence, as described above. Throughout either sequence, microcontroller 400 may periodically check the voltage at contact 244 to make sure that the strip is still inserted in strip connector 216. Alternatively, an interrupt may notify microcontroller 400 of a voltage increase at contact 244 caused by removal of the strip.

In this way, the information-providing connector voltage drop developed across the information-providing connector performs several functions in meter 200. First, the information-encoding connector voltage can wake up meter 200 from a sleep mode to an active mode. Second, meter 200 can determine the strip type from the magnitude of the information-encoding connector voltage. Third, the information-encoding connector voltage can let meter 200 know that the strip is still inserted in strip connector 216, as meter 200 proceeds with either the test strip or check strip sequence. Finally, any measured intrinsic electrical property of the information-providing connector can be used to reference a memory location in the meter containing one or more calibration parameters specific to the test strip.

Preferred embodiments of the present invention have been described above. Those skilled in the art will understand, however, that changes and modifications may be made to these embodiments without departing from the true scope and spirit of the invention, which is defined by the claims.

1. Test strip for measuring an analyte level in a fluid sample, comprising:
a sample chamber configured to receive the fluid sample;
a plurality of electrodes configured to produce at least one current measurement related to the analyte level in the fluid sample; and
at least one information-providing connector having an intrinsic electrical property representative of at least one test strip calibration parameter specific to the test strip.

2. The test strip of claim 1, wherein the fluid sample is a blood sample and the analyte is blood glucose.

3. The test strip of claim 1, wherein the at least one calibration parameter includes temperature corrections.

4. The test strip of claim 1, wherein the at least one calibration parameter includes voltage parameters to be used by a meter performing measurements with the test strip.

5. The test strip of claim 1, wherein the at least one calibration parameter includes information about how many measurements should be made by a meter performing measurements with the test strip.

6. The test strip of claim 1, wherein the at least one calibration parameter includes an identifier identifying a lot of test strips to which the test strip belongs.

7. The test strip of claim 1, wherein the at least one calibration parameter includes a code identifying a brand of the test strip.

8. The test strip of claim 1, wherein the at least one calibration parameter includes a code identifying a model of meter to be used with the test strip.

9. The test strip of claim 1, wherein the at least one calibration parameter includes an expiration date of the test strip.

10. The test strip of claim 1, wherein the intrinsic electrical property is an electrical resistance.

11. A system for measuring an analyte level in a fluid sample, comprising:
a test strip including:
a sample chamber configured to receive the fluid sample;
a plurality of electrodes configured to produce at least one current measurement related to the analyte level in the fluid sample; and
at least one information-encoding connector having an intrinsic electrical property representative of at least one test strip calibration parameter specific to the test strip; and
a meter including:
a strip connector for receiving the test strip;
a processor;
a memory having a plurality of locations each configured to store at least one calibration parameter; and
a data acquisition system controlled by the processor and configured to:
measure an intrinsic electrical property of the at least one information-encoding connector;
obtain at least one test strip calibration parameter corresponding to the test strip from at least one predetermined location in the memory based on the intrinsic electrical property of the at least one information-encoding connector;
apply at least one voltage to at least one of the plurality of electrodes; and
measure the at least one current measurement related to the analyte level.

12. The system of claim 11, wherein the fluid sample is a blood sample and the analyte is blood glucose.

13. The system of claim 11, wherein the at least one calibration parameter includes temperature corrections.

14. The system of claim 11, wherein the at least one calibration parameter includes voltage parameters to be used by a meter performing measurements with the test strip.

15. The system of claim 11, wherein the at least one calibration parameter includes information about how many measurements should be made by a meter performing measurements with the test strip.

16. The system of claim 11, wherein the at least one calibration parameter includes an identifier identifying a lot of test strips to which the test strip belongs.

17. The system of claim 11, wherein the at least one calibration parameter includes a code identifying a brand of the test strip.

18. The system of claim 11, wherein the at least one calibration parameter includes a code identifying a model of meter to be used with the test strip.

19. The system of claim 11, wherein the at least one calibration parameter includes an expiration date of the test strip.

20. The system of claim 11, wherein the intrinsic electrical property is an electrical resistance.
